(19) United States
(12) Patent Application Publication
(10) Pub. No.: US 2016/0239263 A1
(43) Pub. Date: Aug. 18, 2016

(54) DUAL-CLOCK FIFO APPARATUS FOR PACKET TRANSMISSION

(71) Applicant: Electronics and Telecommunications Research Institute, Daejeon (KR)

(72) Inventor: Chan-Ho PARK, Daejeon (KR)

(21) Appl. No.: 15/015,694

(22) Filed: Feb. 4, 2016

(30) Foreign Application Priority Data
Feb. 13, 2015 (KR) 10-2015-0021978

(51) Int. Cl. G06F 5/14; G06F 1/12

(52) U.S. Cl. CPC G06F 5/14; G06F 1/12; G06F 2205/067

(57) ABSTRACT

Disclosed is a dual-clock FIFO apparatus for packet transmission. The FIFO apparatus includes a multi-clock data queue which stores packets and has different read and write clock domains, a packet information queue configured to operate in the write clock domain and to store information data and a tail pointer for the packets, stored in the multi-clock data queue, when writing of packets to the multi-clock data queue is completed, a write state machine configured to operate in the write clock domain, and to read information and pointer data from the packet information queue and notify a read state machine that a packet is ready to read, and the read state machine configured to operate in a read clock domain, to determine whether a packet to be read is ready, and to monitor reading procedure of packet in the multi-clock data queue.

### CROSS REFERENCE TO RELATED APPLICATION

This application claims the benefit of Korean Patent Application No. 10-2015-0021978, filed Feb. 13, 2015, which is hereby incorporated by reference in its entirety into this application.

### BACKGROUND OF THE INVENTION

1. Technical Field

The present invention generally relates to a dual-clock First-In First-Out (FIFO) apparatus for packet transmission, and more particularly, to a FIFO apparatus for packet data delivery between hardware logic devices having different clock domains in a chip.

2. Description of the Related Art

The design of First-In First-Out (FIFO) devices is a common and important issue in designing an Application Specific Integrated Circuit (ASIC) or a Field Programmable Gate Array (FPGA).

FIFO uses two ports for input and output, and is operated with a single clock in some cases, but may be frequently operated with two clocks. In this case, the point of design is to minimize the problem occurring in a relationship between two clocks.

Although not being the problem of only a FIFO, the delivery of data between two logic devices having different clock domains requires a considerably careful design. In this way, the problem occurring in transmitting data between two clocks that are not synchronized with each other is referred to as the problem of metastability. This corresponds to the problem in that the setup and hold times of registers are not satisfied and then unstable values are obtained. In the design of a FIFO, such a problem occurs in a portion in which head and tail pointers are compared with each other to generate empty and full signals. To solve this problem, methods of converting a pointer into a gray code and adding a synchronizer are used.

Generally, the unit of data considered by FIFO is a word that is recorded per one clock. However, for hardware logic with layered architecture, there are many cases where a packet composed of several words is used as the unit of data transmission. In some cases, information analyzed in one layer is delivered to other layers together with the packet to help packet data processing.

As preceding technologies related to the present invention, there are disclosed U.S. Patent Application Publication No. 2012-0294315 (entitled “Packet Buffer Comprising a Data Section and a Data Description Section”) and U.S. Pat. No. 8,417,982 (entitled “Dual-Clock First-In First-Out (FIFO) Memory System”).

### SUMMARY OF THE INVENTION

Accordingly, the present invention has been made keeping in mind the above problems occurring in the prior art, and an object of the present invention is to provide a dual-clock FIFO apparatus, which facilitates the transmission of packet data between hardware logics that use different clocks upon designing hardware.

In accordance with an aspect of the present invention to accomplish the above object, there is provided a dual-clock First-In First-Out (FIFO) apparatus for packet transmission, including a multi-clock data queue configured to store packets and to have different read and write clock domains; a packet information queue configured to operate in the write clock domain and to store additional information data and a tail pointer (IPD) for the packets, stored in the multi-clock data queue, when writing of packets to the multi-clock data queue is completed; a write state machine configured to operate in the write clock domain, and to read the information and pointer data from the packet information queue and notify a read state machine that a packet is ready to read; and a read state machine configured to operate in a read clock domain, to determine whether a packet to be read is ready, and to monitor reading procedure of packet in the multi-clock data queue.

The multi-clock data queue may receive a write error (Write_err) signal when an error is detected while packet are being written and consequently, the corresponding packet is not stored, a write done (Write_done) signal which indicates that the last word of packet has been normally written without an error, and a discard signal that instructs a packet in the queue to be discarded before or while the corresponding packet is read.

When a packet is written to the multi-clock data queue, the write done signal may be input to the packet information queue.

The write done signal may enable the IPD to be written to the packet information queue and the packet information queue may notify the write state machine that the packet information queue is not empty when the IPD is written to the packet information queue.

The write state machine may be configured to, when the packet information queue is not empty, read the IPD from the packet information queue, store the IPD in an IPD register located in the write clock domain, and notify the read state machine that a packet is ready for transmission, through a packet ready register.

The read state machine may be configured to, when recognizing that a packet to be read is ready for transmission by means of the value of the packet ready register, store information of the IPD register in an information data register and a tail pointer register that are located in the read clock domain.

The value of the tail pointer register may be input to the multi-clock data queue, and the multi-clock data queue may change its state to a non-empty state as the value of the tail pointer register has changed, and change its state to the empty state as the packet is read completely.

The read state machine may be configured to, when recognizing that the multi-clock data queue is empty, change the value of the read done register.

The write state machine may be configured to, as the read state machine changes the value of the read done register, store a head pointer value of the multi-clock data queue in the head pointer register.

The value stored in the head pointer register may be compared with a tail pointer output from the multi-clock data queue.

Values delivered between the write clock domain and the read clock domain may include the value of the packet ready output from write state machine, the value of the read done output from read state machine, the value of the IPD register, and the value of the head pointer value from the multi-clock data queue.

Each of the packet ready register and the read done register may solve metastability using a two-stage register (called synchronizer).

The information data register and the tail pointer register are configured such that, even though the values of the information data register and the tail pointer register are not stabilized when the first stage register of the packet ready register has changed, their values are gradually stabilized until the second stage register of the packet ready register is changed.

The multi-clock data queue may include dual-port memory configured to have different write and read clock domains read; a tail pointer control unit configured to receive the write error signal and the write done signal and to operate in response to the received signals; and a head pointer control unit configured to receive the discard signal and the value of the tail pointer register located in the read clock domain and to operate in response to the received signal and value.

The tail pointer control unit may be configured to, when the write error signal is input, replace the current tail pointer register with the previous tail pointer register, thus discarding a packet that is currently being written.

The tail pointer control unit may be configured to, when the write done signal is input, fetch the value from the current tail pointer register and store the value in the previous tail pointer register.

The head pointer control unit may be configured to, when the discard signal is input, replace the value of the current head pointer register with the value of the tail pointer register.

The head pointer value and the tail pointer value of the multi-clock data queue denote outputs of values of the current head pointer register and the current tail pointer register.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing examples of input/output signals of a dual-clock FIFO apparatus for packet transmission according to an embodiment of the present invention;

FIG. 2 is a diagram showing the internal structure of a dual-clock FIFO apparatus for packet transmission according to an embodiment of the present invention;

FIG. 3 is a diagram showing the 4-phase interface of two state machines using a packet ready (Pkt_rdy) register and a read done (Read_done) register shown in FIG. 2; and

FIG. 4 is a diagram showing the internal configuration of a multi-clock data queue shown in FIG. 2.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

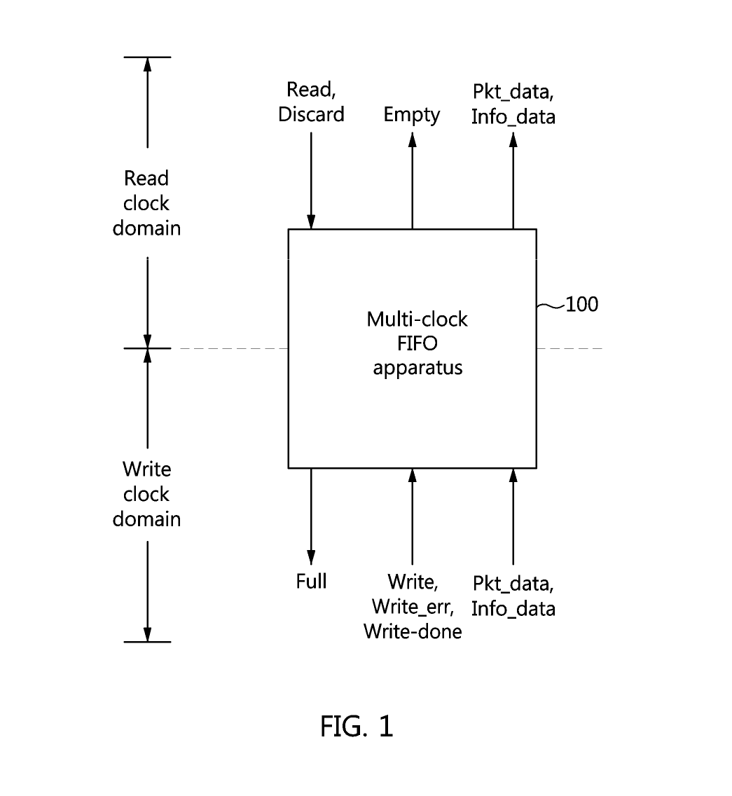

FIG. 1 is a diagram showing examples of input/output signals of a dual-clock FIFO apparatus for packet transmission according to an embodiment of the present invention.

A FIFO apparatus 100 according to an embodiment of the present invention uses a write error (Write_err) signal, a write done (Write_done) signal, information data (Info_data), and an elimination (Discard) signal, none of which are used in a typical FIFO.

Since the FIFO apparatus 100 according to the embodiment of the present invention is intended to deliver packets, the Write_err signal, the Write_done signal, the Info_data, and the discard signal are required.

The write error (Write_err) signal of a write clock domain is a signal input when there is no need to deliver a certain packet because an error is detected while the packet is being written to a multi-clock data queue. The Write_err signal may be easily used when integrity is checked in an on-the-fly integrity checking manner. For example, if it is recognized that an error in a packet checksum is detected while the packet checksum is simultaneously calculated and written to the FIFO apparatus 100, packets written to date may be discarded with this signal (i.e. the Write_err signal).

The Write_done signal of the write clock domain is a signal indicating that even the last packet has been normally written to the multi-clock data queue. Here, information called information data (Info_data) may be provided together with the Write_done signal. The information data (Info_data) is a signal for allowing logic in the write clock domain to simultaneously write and analyze packets and for notifying logic in a read clock domain of part of the analyzed information. The logic in the read clock domain may preview such information (i.e. information data: Info_data) before reading packet data, and suitable logic conforming to the previewed information may read the corresponding packet data.

The discard signal of the read clock domain is a signal for instructing all of the corresponding packets to be discarded before or while the packet data is read. When an erroneous or unnecessary packet appears as a result of referring to the information data (Info_data) provided by the write clock domain or analyzing packet data during the reading of the packet data, if the packet is discarded in response to the corresponding signal (i.e. the discard signal), a subsequent packet may be rapidly read. In addition, signals, such as a word count signal (Word_count) indicating the size of packets, may be provided.

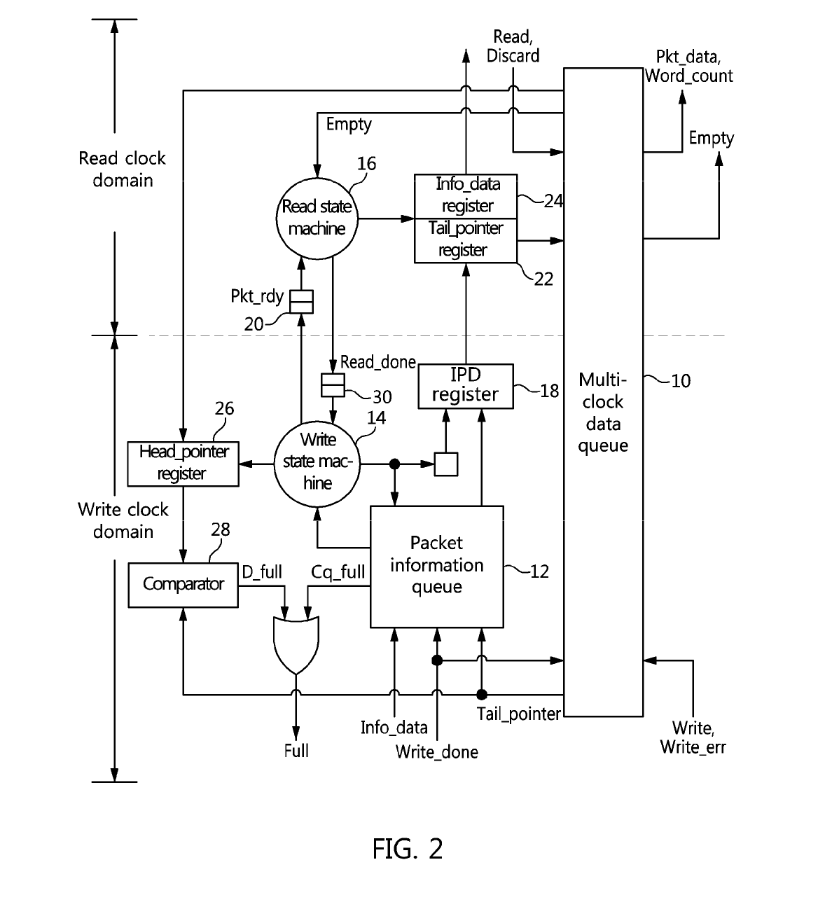

FIG. 2 is a diagram showing the internal structure of a dual-clock FIFO apparatus for packet transmission according to an embodiment of the present invention.

The dual-clock FIFO apparatus for packet transmission according to the embodiment of the present invention includes a multi-clock data queue 10, a packet information queue 12, a write state machine 14, and a read state machine 16.

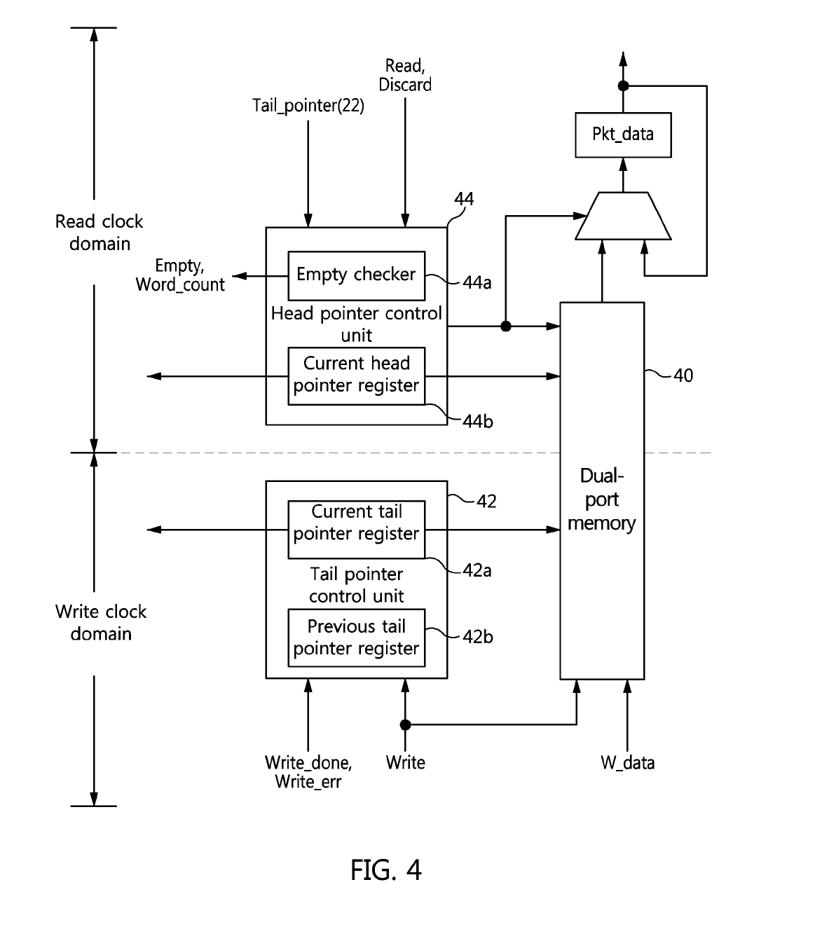

The multi-clock data queue 10 is a queue for storing actual packet data. The multi-clock data queue 10 is implemented using dual-port memory and additional logic, and must be designed to have a size in which one or more of packets having a maximum size may be accommodated. A detailed embodiment is illustrated in FIG. 4. The multi-clock data queue 10 extends over a read clock domain and a write clock domain.

The packet information queue 12 is a typical FIFO queue that uses a single clock. The packet information queue 12 may store information of 1 word per packet. Therefore, the packet information queue 12 must have, as depth, the degree corresponding to the number of packets desired to be maximally stored in the multi-clock data queue 10. The information stored in the packet information queue 12 includes a tail pointer for each packet stored in the multi-clock data queue 10, as well as information data (Info_data) indicated as an input in FIG. 1. Therefore, when 10 bits are used as the tail pointer of the multi-clock data queue 10, and 6 bits are used as the information data (Info_data), the word width of the packet information queue 12 must be implemented using 16 bits. The packet information queue 12 is operated in the write clock domain.

When the writing of a single packet to the multi-clock data queue 10 is completed, the write state machine 14 reads the corresponding information (i.e. the value of the tail pointer) from the packet information queue 12, and notifies the read state machine 16 of the read value. The logic of the write clock domain writes data to the multi-clock data queue 10 and then indicates that the packet has been normally written using the Write_done signal. The Write_done signal is used as a signal for writing the tail pointer and information data (Info_data) to the packet information queue 12. When data is written to the packet information queue 12, the packet information queue 12 notifies the write state machine 14 that the queue 12 is not in an empty state. Accordingly, the write state machine 14 reads data from the packet information queue 12 and stores the read data in an IPD register 18 while notifying the read state machine 16 that the packet is ready for transmission, through a packet ready (Pkt_rdy) register 20. The write state machine 14 is operated in the write clock domain.

When recognizing that the packet to be read is ready for transmission by means of the value in the packet ready (Pkt_rdy) register 20, the read state machine 16 stores the information of the IPD register 18 both in an information data (Info_data) register 24 and a tail pointer (Tail_pointer) register 22 that are located in the read clock domain. Here, the information data register 24 is used to allow the logic in the read clock domain to preview the information of the packet. Further, the value of the tail pointer register 22 is input to the multi-clock data queue 10. The read state machine 16 is operated in the read clock domain.

When the value in the tail pointer register 22 changes, the multi-clock data queue 10 changes its state to a state other than an empty state, and the logic that has recognized this may read the data.

Once a single packet is read, the multi-clock data queue 10 changes its state to an empty state (actually, more data that is successively recorded may be present). When the read state machine 16 that has recognized this state changes the value of a read done (Read_done) register 30, the write state machine 14 stores the head pointer value of the multi-clock data queue 10 in a Head_pointer register 26. When the empty state of the packet information queue 12 is monitored and a new packet is found to be present, the write state machine 14 repeats the operation of reading the packet.

Further, in the write clock domain, the value stored in the head pointer register 26 is compared by a comparator 28 with the tail pointer of the multi-clock data queue 10 and is used to determine whether the buffer is in a full state. Since packet data cannot be written even when the packet information queue 12 is in a full state, the value of a logic OR operation on the two full states is used as a final full state value.

In a given structure, the total number of values delivered between different clock domains is four (i.e. two control signals and two data values). Here, the two control signals are the values of the Pkt_rdy register 20 and the Read_done register 30. Further, the two data values are the values of the IPD register 18 and the head pointer register 26.

Since data may not be stabilized at the intersection of the two clock domains, each of the Pkt_rdy register 20 and the Read_done register 30 solves the problem of metastability using a two-stage register (e.g. a synchronizer).

In the state in which the values of the information data register 24 and the tail pointer register 22 are not stabilized, even if it is recognized that the value of the first stage register of the Pkt_rdy register 20 has changed, the values of the information data register 24 and the tail pointer register 22 are gradually stabilized while going through the two-stage register of the packet ready register 20. In this state, the write state machine 14 is configured such that the state thereof is not changed until the change of the Read_done register 30 is recognized, thus removing additional unstable factors of signals. The Read_done register 30, the head pointer register 26, and the read state machine 16 are also operated using the same mechanism.

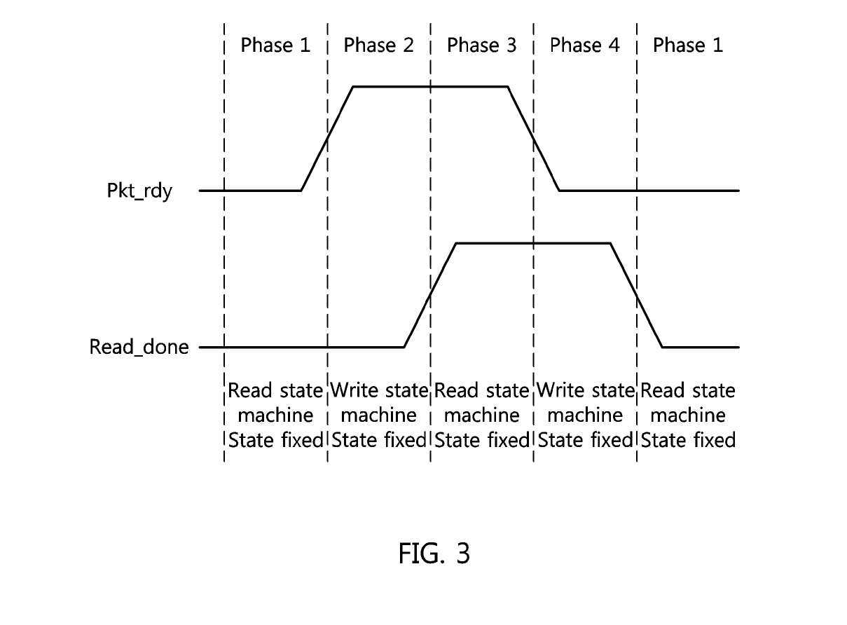

The 4-phase interface of two state machines using the Pkt_rdy register 20 and the Read_done register 30 is illustrated in FIG. 3.

In FIG. 3, the state of phase 1 is the state in which the write state machine 14 performs the operation of determining whether any packet is stored, and if it is determined that any packet is stored, reading the corresponding packet information, storing it in the IPD register 18, and notifying the read state machine 16 of the packet information through the Pkt_rdy register 20. At this time, since the state of the read state machine 16 is fixed, the value of the Read_done register 30 is not changed.

The state of phase 2 is the state in which the read state machine 16 performs the operation of determining that a packet to be read is present, storing the corresponding packet data in the information data (Info_data) register 24 and the tail pointer (Tail_pointer) register 22, and if external logic reads the packet data, notifying the write state machine 14 that the data has been read, through the Read_done register 30. If the value of the tail pointer register 22 is stored as a new value, the empty signal of the multi-clock data queue 10 changes to 0. If the external logic reads packet data, the empty signal changes back to 1. Therefore, the read state machine 16 may monitor the empty signal and detect the progress of the operation. At this time, since the state of the write state machine 14 is fixed, the value of the Pkt_rdy register 20 is not changed. Even if the state of the write state machine 14 is fixed, such a state is not related to the writing of packet data by the external logic located in the write clock domain, thus enabling the writing of the packet data to continue without stopping.

The state of phase 3 is the state in which the write state machine 14 performs the operation of storing the head pointer value of the multi-clock data queue 10 in the head pointer (Head_pointer) register 26, and returning the value of the Pkt_rdy register 20 to 0. Here, the state of the read state machine 16 is fixed at the state of waiting the value of the Pkt_rdy register 20 to change.

The state of phase 4 is the state in which the read state machine 16 performs the operation of recognizing the change in the value of the Pkt_rdy register 20 and returning the value of the Read_done register 30 to 0. At this time, the state of the write state machine 14 is fixed at the state of waiting for the value of the Read_done register 30 to change.

Meanwhile, according to the need, each state machine may be further complicated, but a scheme for eliminating the waste of clocks in such a way as to omit phase 3 and phase 4 and use 2-phase interface signals may also be used.

FIG. 4 is a diagram illustrating the internal configuration of the multi-clock data queue 10 shown in FIG. 2.

The multi-clock data queue 10 includes dual-port memory 40, a tail pointer control unit 42, and a head pointer control unit 44.

The dual-port memory 40 extends over a write clock domain and a read clock domain. Other logic devices are separately disposed in any of the domains.

The tail pointer control unit 42 includes a current tail pointer register 42a used as a typical tail pointer and a previous tail pointer register 42b for storing the tail pointer when the storage of a previous packet is terminated. When a write error (Write_err) signal is input to the tail pointer control unit 42, the current tail pointer register 42a is replaced with the previous tail pointer register 42b, thus enabling the Write_err signal to be used to discard the packet that is currently being written. Meanwhile, when the write done (Write_done) signal is input to the tail pointer control unit 42, the value of the current tail pointer register 42a needs only to be fetched and stored in the previous tail pointer register 42b. The value of the current tail pointer register 42a is also output to the outside of the multi-clock data queue 10 and is used, as shown in FIG. 2.

The head pointer control unit 44 receives and uses the value of the tail pointer register 22 as a tail pointer value. Therefore, as a result of checking by an empty checker 44a, an empty signal being ‘1’ means that the reading of packet data currently being read has been completed, rather than meaning that the entirety of the dual-port memory 40 is empty. Further, when a discard signal is input, the head pointer control unit 44 replaces the value of a current head pointer register 44b with the value of the tail pointer register 22, thus enabling the discard signal to be used to discard the entire packet that is currently being read.

The head pointer value and the tail pointer value of the multi-clock data queue 10 denote the outputs of the values of the current head pointer register 44b and the current tail pointer register 42a.

The above-described present invention implements a (store & forward format) FIFO in which data is stored and then forwarded on a packet basis, and includes the functions of cancelling the writing of corresponding packets during writing, or discarding all corresponding packets during reading. Further, since the pointer values that are compared are not frequently changed due to packet-based processing, the problem of metastability can be solved without requiring the conversion into a gray code.

As described above, in accordance with the present invention having the above configuration, the transmission of packets may be easily performed between hardware logic devices using different clocks when designing hierarchical hardware that uses a packet as a processing unit.

Further, when an error is detected during the writing of a packet, it may be removed in advance, thus reducing the operational waste of hardware logic which desires to read information from a FIFO, for example, reading and analyzing unnecessary information.

Furthermore, there is an advantage in that important packet information is received before an actual packet is read and analyzed, so that the process to be handled is prepared in advance and is operated, or so that, when the process is determined to be unnecessary, the packets may be simultaneously discarded.

In particular, the present invention may be easily used between the network and hardware logic devices, such as Peripheral Component Interconnect Express (PCI-Express), which use packets.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A dual-clock First-In First-Out (FIFO) apparatus for packet transmission, comprising:
a multi-clock data queue configured to store packets and to have different read and write clock domains;
a packet information queue configured to operate in the write clock domain and to store information data and a tail pointer (IPD) for the packets, stored in the multi-clock data queue, when writing of packets to the multi-clock data queue is completed;
a write state machine configured to operate in the write clock domain, and to read the IPD from the packet information queue and notify a read state machine that a packet is ready to read; and
a read state machine configured to operate in a read clock domain, to determine whether a packet to be read is ready, and to monitor reading procedure of packet in the multi-clock data queue.

2. The dual-clock FIFO apparatus of claim 1, wherein the multi-clock data queue receives a write error (Write_err) signal when an error is detected while packets are being written and consequently, the corresponding packet is not stored, a write done (Write_done) signal which indicates that the last word of packet has been normally written without an error, and a discard signal that instructs a packet in the queue to be discarded before or while the corresponding packet is read.

3. The dual-clock FIFO apparatus of claim 2, wherein when a packet is written to the multi-clock data queue, the write done signal is input to the packet information queue.

4. The dual-clock FIFO apparatus of claim 3, wherein:
the write done signal enables the IPD to be written to the packet information queue, and
the packet information queue notifies the write state machine that the packet information queue is not empty when the IPD is written to the packet information queue.

5. The dual-clock FIFO apparatus of claim 4, wherein the write state machine is configured to, when the packet information queue is not empty, read the IPD from the packet information queue, store the IPD in an IPD register located in the write clock domain, and notify the read state machine that a packet is ready for transmission, through a packet ready register.

6. The dual-clock FIFO apparatus of claim 5, wherein the read state machine is configured to, when recognizing that the packet to be read is ready for transmission by means of the value of the packet ready register, store information of the IPD register in an information data register and a tail pointer register that are located in the read clock domain.

7. The dual-clock FIFO apparatus of claim 6, wherein:
the value of the tail pointer register is input to the multi-clock data queue, and
the multi-clock data queue changes its state to a non-empty state as the value of the tail pointer register has changed, and changes its state to the empty state as the packet is read completely.

8. The dual-clock FIFO apparatus of claim 7, wherein the read state machine is configured to, when recognizing that the multi-clock data queue is empty, change the value of the read done register.

9. The dual-clock FIFO apparatus of claim 8, wherein the write state machine is configured to, as the read state machine changes the value of the read done register, store a head pointer value of the multi-clock data queue in the head pointer register.

10. The dual-clock FIFO apparatus of claim 9, wherein the value stored in the head pointer register is compared with a tail pointer output from the multi-clock data queue.

11. The dual-clock FIFO apparatus of claim 9, wherein values delivered between the write clock domain and the read clock domain include the value of the packet ready output from the write state machine, the value of the read done output from read state machine, the value of the IPD register, and the value of the head pointer value from the multi-clock data queue.

12. The dual-clock FIFO apparatus of claim 11, wherein each of the packet ready register and the read done register solves metastability using a two-stage register.

13. The dual-clock FIFO apparatus of claim 12, wherein the information data register and the tail pointer register are configured such that, even though the values of the information data register and the tail pointer register are not stabilized when the first stage register of the packet ready register has changed, their values are gradually stabilized until the second stage register of the packet ready register is changed.

14. The dual-clock FIFO apparatus of claim 9, wherein the multi-clock data queue comprises:
dual-port memory configured to have different write and read clock domains;
a tail pointer control unit configured to receive the write error signal and the write done signal and to operate in response to the received signals; and
a head pointer control unit configured to receive the discard signal and the value of the tail pointer register located in the read clock domain and to operate in response to the received signal and value.

15. The dual-clock FIFO apparatus of claim 14, wherein the tail pointer control unit is configured to, when the write error signal is input, replace a current tail pointer register with a previous tail pointer register, thus discarding a packet that is currently being written.

16. The dual-clock FIFO apparatus of claim 15, wherein the tail pointer control unit is configured to, when the write done signal is input, fetch a value from a current tail pointer register and store the value in a previous tail pointer register.

17. The dual-clock FIFO apparatus of claim 15, wherein the head pointer control unit is configured to, when the discard signal is input, replace a value of a current head pointer register with the value of the tail pointer register.
